(19) United States
(12) Patent Application Publication
(10) Pub. No.: US 2008/0051092 A1
(43) Pub. Date: Feb. 28, 2008

(54) METHOD AND APPARATUS OF PERFORMING HANDOVER IN MOBILE NODE, INFORMATION SERVER, AND METHOD OF TRANSMITTING HANDOVER INFORMATION FROM INFORMATION SERVER TO MOBILE NODE

(75) Inventors: Soo-hong Park, Gwangju-si (KR); Han-sung Kim, Seongnam-si (KR); Cheol-ju Hwang, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/685,460

(22) Filed: Mar. 13, 2007

Related U.S. Application Data
(60) Provisional application No. 60/840,033, filed on Aug. 25, 2006.

(30) Foreign Application Priority Data
Nov. 24, 2006 (KR) 2006-117096

(51) Int. Cl. H04Q 7/20

(52) U.S. Cl. 455/437

(57) ABSTRACT

A method and apparatus of performing handover in a mobile node using an intrinsic value of a point of attachment (PoA), a method of transmitting handover information to the mobile node, and an information server. The method of performing handover in a mobile node includes determining an intrinsic value of a current PoA to which the mobile node is connected; and performing handover using the determined intrinsic value. The mobile node that does not include a GPS or does not support a specific protocol transmits the location thereof to an IS using an PoA identifier that is an intrinsic value of a current PoA to which the MN is connected, so that the IS can be informed of the current PoA, and quickly and promptly determine adjacent PoAs for performing handover.

### CROSS-REFERENCE TO RELATED APPLICATIONS

This application claims the benefits of U.S. Patent Application No. 60/840,033, filed on 25 Aug. 2006, in the U.S. Patent and Trademark Office, and of Korean Patent Application No. 2006-117096, filed on 24 Nov. 2006, in the Korean Intellectual Property Office, the disclosures of which are incorporated herein by reference.

### BACKGROUND OF THE INVENTION

1. Field of the Invention

Aspects of the present invention relate to a communication system and, more particularly, to a method and apparatus of performing handover in a mobile node using an intrinsic value of a point of attachment (PoA), a method of transmitting handover information to the mobile node, and an information server.

2. Description of the Related Art

To perform handover, a mobile node needs information on a radio area before and after the mobile node moves, a current point of attachment (PoA) to which the mobile node is connected, and information on a PoA to which the mobile node is to be connected. The information is called “handover information”.

When the mobile node requests handover information from an information server (IS), the mobile node is required to notify the IS of the mobile node's location. The mobile node can determine the location through a global positioning system (GPS) and can receive handover information by transmitting the location to the IS. However, not all mobile nodes include GPS. A mobile node that does not include GPS cannot determine the mobile node's location. When a specific radio protocol uses an intrinsic method, a mobile node that uses a different radio protocol cannot determine the mobile node's location.

Accordingly, a method of transmitting the location of a mobile node to an IS and receiving handover information from the IS is needed.

### SUMMARY OF THE INVENTION

Aspects of the present invention provide a method and apparatus of performing handover wherein a mobile node, which does not use a global positioning system (GPS), determines location information relating to the mobile node, transmits the location information to an information server (IS), and receives handover information from the IS; and a computer readable recording medium storing a computer program to execute the handover performing method.

Other aspects of the present invention provide an IS that receives location information from a mobile node and transmits handover information to the mobile node, a method of transmitting the handover information from the IS to the mobile node, and a computer readable recording medium storing a computer program to execute the handover information transmitting method.

Additional aspects of the present invention also provide an information recording medium storing a data format of a message requesting information used to perform handover to an IS in a mobile node, and an information recording medium storing a data format of a message used to transmit handover information from the mobile node to the IS.

According to an aspect of the present invention, there is provided a method of performing handover in a mobile node comprising: determining an intrinsic value of a current PoA (point of attachment) to which the mobile node is connected; and performing handover using the determined intrinsic value.

According to another aspect of the present invention, there is provided an apparatus for performing handover using a mobile node comprising: an intrinsic value determining unit determining an intrinsic value of a current PoA to which the mobile node is connected; and a handover performing unit performing handover using the determined intrinsic value.

According to another aspect of the present invention, there is provided a method of transmitting handover information from an information server to a mobile node comprising: receiving an information request message including an intrinsic value of current PoA to which the mobile node is connected from the mobile node; determining PoAs adjacent to a PoA corresponding to the intrinsic value; and transmitting an information response message including information on the determined adjacent PoAs to the mobile node.

According to another aspect of the present invention, there is provided an information server that transmits handover information to a mobile node comprising: a message receiver receiving an information request message including an intrinsic value of current PoA to which the mobile node is connected from the mobile node; an adjacent PoA determiner determining PoAs adjacent to a PoA corresponding to the intrinsic value; and a message transmitter transmitting an information response message including information on the determined adjacent PoAs to the mobile node.

According to another aspect of the present invention, there is provided an information recording medium storing a data format of a message requesting information necessary for performing handover to an information server from a mobile node, wherein the message is an information request message including an intrinsic value of a current PoA to which the mobile node is connected.

According to another aspect of the present invention, there is provided an information recording medium storing a data format of a message used to transmit handover information from an information server to a mobile node, wherein the message is an information response message including an intrinsic value of a current PoA to which the mobile node is connected.

According to another aspect of the present invention, there is provided a computer readable recording medium having embodied thereon a computer program for executing a method of performing handover in a mobile node, the method comprising: determining an intrinsic value of a current PoA to which the mobile node is connected; and performing handover using the determined intrinsic value.

According to another aspect of the present invention, there is provided a computer readable recording medium having embodied thereon a computer program for executing a method of transmitting handover information from an information server to a mobile node, the method comprising: the information server receiving an information request message including an intrinsic value of current PoA to which the mobile node is connected from the mobile node; determining PoAs adjacent to a PoA corresponding to the intrinsic value; and transmitting an information response message including information on the determined adjacent PoAs to the mobile node.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart illustrating a handover performing technique according to an embodiment of the present invention;

FIG. 2 is a flowchart illustrating a technique of determining an intrinsic value of a point of attachment (PoA) according to an embodiment of the present invention;

FIG. 3 is a flowchart illustrating a handover performing technique by a mobile node using a determined intrinsic value of a PoA according to an embodiment of the present invention;

FIG. 4 is a block diagram of a handover performing apparatus of a mobile node according to an embodiment of the present invention;

FIG. 5 is a flowchart illustrating a technique of transmitting handover information from an information server (IS) to a mobile terminal according to an embodiment of the present invention;

FIG. 6 is a block diagram of an IS according to an embodiment of the present invention;

FIG. 7 illustrates a network environment where a mobile node performs handover according to an embodiment of the present invention;

FIG. 8 illustrates a network environment where handover is performed according to an embodiment of the present invention;

FIG. 9 is a view illustrating network layers of a mobile node according to an embodiment of the present invention;

FIG. 10 illustrates a format of information included in a message using a media independent handover (MIH) protocol according to an embodiment of the present invention;

FIG. 11 illustrates a format of an information request message according to an embodiment of the present invention;

FIG. 12 illustrates a format of a field Querier Location according to an embodiment of the present invention;

FIG. 13 illustrates a format of a field Reporting Template illustrated in FIG. 11 according to an embodiment of the present invention;

FIG. 14 illustrates a format of a PoA location information element (IE) according to an embodiment of the present invention;

FIG. 15 illustrates a value of a field LocationInformation when the type of location information is civic location information;

FIG. 16 illustrates a value of a field LocationInformation when the type of location information is geospatial location information;

FIG. 17 illustrates the content of a field Value of a PoA location IE when the type of information location is a PoA identifier;

FIG. 18 illustrates a format of an information response message according to an embodiment of the present invention;

FIG. 19 is a flowchart of a handover performing method including an exchange of messages between objects according to an embodiment of the present invention; and

FIG. 20 is a flowchart of a handover performing method when an MN is already informed of a PoA ID of a current PoA to which the MN is connected according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

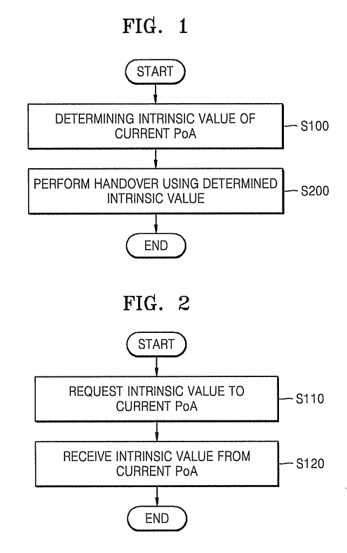

FIG. 1 is a flowchart illustrating a handover technique according to an embodiment of the present invention. The handover technique comprises determining an intrinsic value of a current point of attachment (PoA) to which a mobile node is connected (operation 100) and performing handover using the intrinsic value (operation 200).

The mobile node notifies an IS of the mobile node's location and receives handover information from the IS to perform handover. The intrinsic value of the current PoA is used to indicate the location of the mobile node. A PoA identifier may be used as the intrinsic value of the current PoA.

Civic location information or geospatial location information may be used as location information indicating the location of the mobile node or the PoA. The location information may be acquired via a global positioning system (GPS) or an assisted GPS or may be determined based on information provided by a specific radio protocol. However, methods of acquiring the location information using extrinsic information (such as GPS or a wireless/radio protocol) have some disadvantages. When the location information is acquired via the GPS or the assisted GPS, a mobile node that does not include the GPS cannot be informed of the location thereof.

To acquire the location information using the information provided by the specific radio protocol, triangulation, cell information, wireless LAN (WLAN) access point (AP) information, and the like are used. A mobile node that does not use the specific radio protocol cannot acquire the location information and thus is not informed of the mobile node's location thereof. For example, when the WLAN AP information is used to acquire the location information, the WLAN AP information is provided to a mobile node that uses a WLAN protocol specified by the IEEE 802.11 standards. If the mobile node does not use the WLAN protocol, the mobile node will not be able to use the WLAN AP information.

Aspects of the present invention provide a method of providing the mobile node with the location information that does not need GPS and is independent of a particular radio protocol. According to aspects of the present invention, the intrinsic value of the current PoA is used as the location information of the mobile node, so that the location information of the mobile node can be determined without the GPS and irrespective of a specific radio protocol.

An information server (IS) transmits handover information to the mobile node using the location information of the mobile node. The IS determines mobile areas adjacent to the mobile node from the location information of the mobile node, selects the determined mobile areas and information on a PoA included in the mobile areas, and transmits the mobile areas and the information on the PoA to the mobile node. If the location information of the mobile node that requests handover information to the IS is not provided to the IS, the IS might not be able to select information to be provided to the mobile node. In this situation, the IS can determine or estimate the location of the mobile node using another method requiring additional operation and time of the IS. When the IS estimates the location of the mobile node, the IS should transmit information on a broader area than when the IS is informed of the location of the mobile node in order to prevent loss of information necessary to the mobile node.

In view of the above, it is not necessary to provide the precise physical location of the mobile node. For example, information provided by the GPS such as 135 degrees of east longitude, 36 degrees north latitude, or the like is not necessary. The IS may instead use the location information used to select information that is to be provided to the mobile node.

The PoA identifier that is the intrinsic value of the PoA satisfies the above requirements. The IS can determine a network area adjacent to an area where the mobile node is and a PoA by transmitting the intrinsic value of the current PoA to which the mobile node is connected to the IS.

There are a variety of ways to determine the intrinsic value of the current PoA to which the mobile node is connected. When the mobile node moves from a previous radio area to a current radio area, the mobile node has performed handover to the current radio area. If the mobile node receives information on the current PoA from the IS, the mobile node can determine the intrinsic value of the current PoA from the information. If the mobile node first connects to a network or initializes handover information, the mobile node might not be able to determine the intrinsic value of the current PoA.

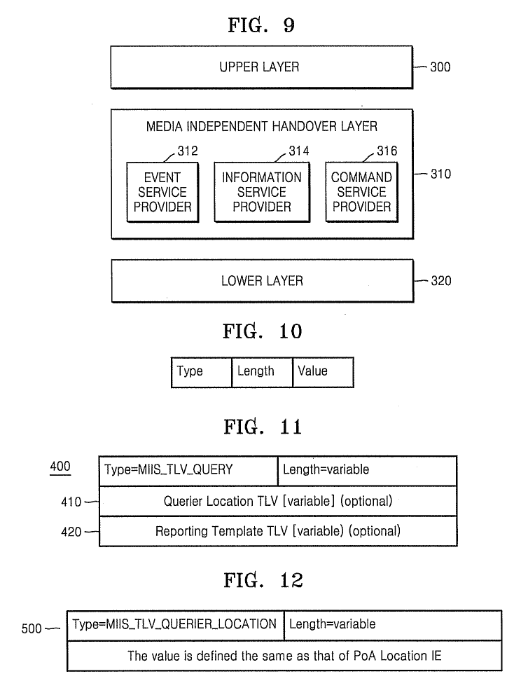

FIG. 2 is a flowchart illustrating a technique of determining an intrinsic value of a PoA according to an embodiment of the present invention. The technique of determining the intrinsic value of the PoA is used when a mobile node is not informed of the intrinsic value of the current PoA to which the mobile node is connected. The mobile node transmits a message to the current PoA requesting the intrinsic value of the current PoA (operation 110). The message may use a media independent handover (MIH) protocol, described below with reference to FIG. 9. The current PoA transmits a message including the intrinsic value thereof to the mobile node in response to the request. The mobile node receives the message (operation 120). The message may be specified by the MIH protocol.

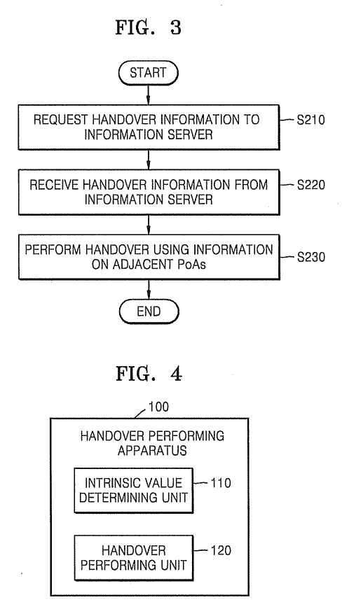

In operation 200 of FIG. 1, the mobile node performs handover using the intrinsic value determined in operation 100. FIG. 3 is a flowchart illustrating a handover technique by a mobile node using a determined intrinsic value of a PoA according to an embodiment of the present invention. The mobile node transmits an information request message to an IS requesting handover information (Operation 210). The information request message includes the intrinsic value of the PoA determined in Operation 100 of FIG. 1.

Referring to FIG. 3, the IS can determine a PoA adjacent to the current PoA to which the mobile node is connected using the intrinsic value of the PoA included in the information request message. The IS retrieves information on the determined PoA from information available to the IS and transmits the selected information to the mobile node via an information response message. The mobile node receives the information response message including the selected information (operation 220). The mobile node performs handover using the received information on the determined PoA (operation 230).

FIG. 4 is a block diagram of a handover performing apparatus 100 of a mobile node according to an embodiment of the present invention. The handover performing apparatus 100 includes an intrinsic value determining unit 110 and a handover performing unit 120.

The intrinsic value determining unit 110 determines an intrinsic value of a current PoA to which the mobile node is connected. The intrinsic value determining unit 110 may perform operation 100 illustrated in FIG. 1. The handover performing unit 120 performs handover using the determined intrinsic value. The handover performing unit 120 may perform operation 200 illustrated in FIG. 1.

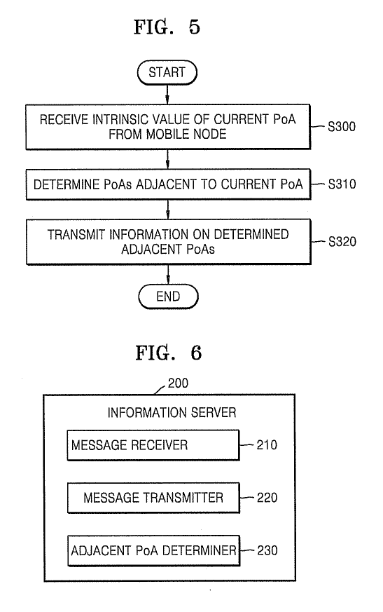

FIG. 5 is a flowchart illustrating a technique of transmitting handover information from an IS to a mobile node according to an embodiment of the present invention. The IS receives an intrinsic value of a current PoA to which the mobile node is connected from the mobile node (operation 300) via an information request message. The IS detects the intrinsic value of the current PoA from the information request message and selects a PoA adjacent to the current PoA (operation 310). The IS obtains information on the selected PoA from information available to the IS and transmits the information to the mobile node via an information response message (operation 320).

FIG. 6 is a block diagram of an IS 200 according to an embodiment of the present invention. The IS 200 includes a message receiver 210, a message transmitter 220, and an adjacent PoA determiner 230.

The message receiver 210 receives an information request message from a mobile node. The information request message includes an intrinsic value of a current PoA to which the mobile node is connected. The message receiver 210 may perform operation 300 illustrated in FIG. 5. The adjacent PoA determiner 230 selects a PoA adjacent to the current PoA corresponding to the intrinsic value. The adjacent PoA determiner 230 may perform operation 310 illustrated in FIG. 5. The message transmitter 220 selects information on the determined PoA from information available to the message transmitter 220 and transmits an information response message including the selected information to the mobile node. The message transmitter 220 may perform operation 320 illustrated in FIG. 5.

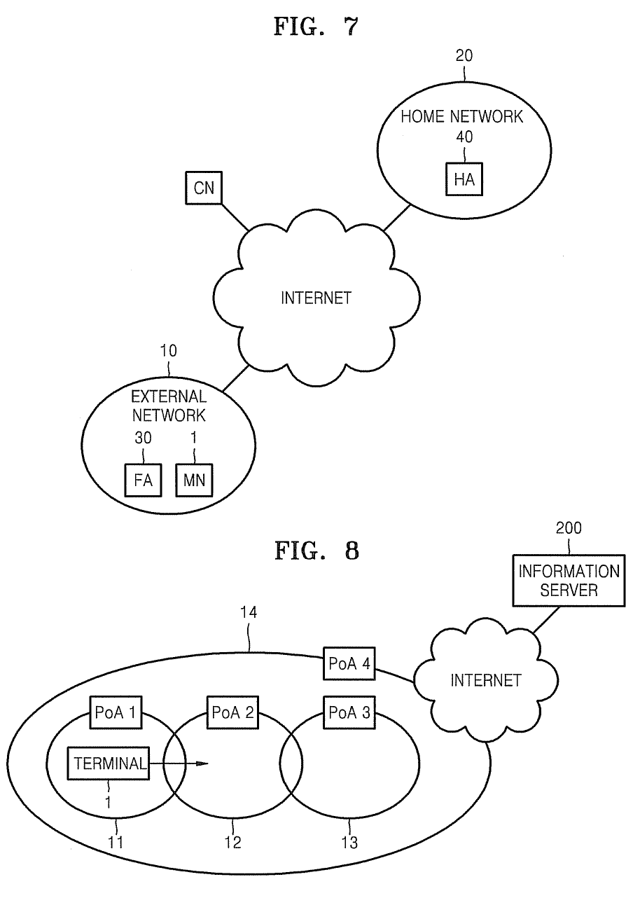

FIG. 7 illustrates a network environment where a mobile node performs handover according to an embodiment of the present invention. The network environment according to an embodiment of the present invention includes a mobile node (MN) 1, an external network 10, a home network 20, a foreign agent (FA) 30, a home agent (HA) 40, Internet, and a correspondent node (CN). The mobile node (MN) 1 may be any mobile device, such as a mobile phone, a personal digital assistant, a portable entertainment device, or a multifunction device (such as a smartphone).

The MN 1 is a mobile device using a mobile communication environment. The MN 1 is connected to the home network 20 to perform a mobile communication. The HA 40 belongs to the home network 20. The external network 10 which the MN 1 has visited is not part of the home network 20. The FA 30 belongs to the external network 10.

When starting mobile communication, the MN 1 registers a home address (HoA) in the HA 40. The HoA is used as a destination address when the CN transmits data to the MN 1. When the MN 1 moves to a different network, the MN 1 registers a care-of address (CoA) in the HA 40 in order to keep the location information of the MN 1 current. While the MN 1 is connected to the external network 10, the MN 1 and the CN communicate data as follows. The MN 1 receives a new address from the FA 30, referred to as the CoA. The MN 1 sends the CoA to the HA 40. The HA 40 binds the CoA of the MN 1 to the HoA of the MN 1.

The CN sets a receiving address of a data packet as the HoA of the MN 1 in order to transmit data to the MN 1. The CN transmits the data packet to the HA 40. The HA 40 analyzes the received data packet and recognizes that the data packet is to be transmitted to the MN 1. The HA 40 locates the CoA of the MN 1 corresponding to the HoA from an address table. The HA 40 sets the CoA as the receiving address of the data packet and forwards the data packet to the MN 1. The data packet is transmitted to the MN 1 in the external network 10 through the Internet.

FIG. 8 illustrates a network environment where handover is performed according to an embodiment of the present invention. The network environment of the present embodiment includes a plurality of PoAs. When an MN 1 belongs to a radio area 11, the MN 1 can be connected to a PoA 1. When the MN 1 belongs to a radio area 12, the MN 1 can be connected to a PoA 2. When the MN 1 belongs to a radio area 13, the MN 1 can be connected to a PoA 3. When the MN 1 belongs to a radio area 14, the MN 1 can be connected to a PoA 4.

The radio areas 11, 12, 13, and 14 partially overlap between the plurality of PoAs. For example, the radio area 11 connected to the PoA 1 and the radio area 12 connected to the PoA2 partially overlap. If the MN 1 moves to an overlapping area, handover is performed so that the MN 1 disconnects from a current PoA to which the MN 1 is connected and connects to a new PoA. For example, the MN 1 may move to the radio area 12 from the radio area 11. The MN 1 is connected to the PoA 1 while in radio area 11. If the MN 1 moves to the radio area 12, the MN 1 is disconnected from the PoA 1. Therefore, if the MN 1 moves to an area where the radio area 11 and the radio area 12 overlap, the MN 1 must decide what PoA to connect to. Thus, the MN 1 must determine if there is a PoA to which the MN 1 can connect. If there are several PoAs to which the MN 1 can connect, the MN 1 should determine the best PoA to connect to. To this end, the MN 1 should receive handover information on adjacent PoAs from an IS 50.

The MN 1 obtains a PoA identifier of the PoA 1 in order to perform handover. The PoA identifier that is an intrinsic value of a PoA is previously determined. A variety of techniques can be employed to determine the PoA identifier. A PoA identifier of a PoA may have a similar value to PoA identifiers of PoAs adjacent to the PoA. The PoA identifier of the PoA may have a different value from PoA identifiers of PoAs far from the PoA. For example, the MN 1 can determine a PoA identifier of the PoA 1 to have a value of 10001, a PoA identifier of the PoA 2 to have a value of 10002, a PoA identifier of the PoA 3 to have a value of 10003, a PoA identifier of the PoA 4 to have a value of 10004, and a PoA identifier of a PoA far from the PoAs 1, 2, 3, and 4 to have a value greater than 20000.

The IS 200 may have a table in which the locations of the PoAs 1, 2, 3, and 4 correspond to PoA identifiers, respectively. The IS 200 can use the table to determine the location of a PoA corresponding to a PoA identifier and PoAs adjacent to the PoA. The IS 50 transmits an information response message including PoA identifiers of the adjacent PoAs to the MN 1.

FIG. 9 illustrates network layers of the MN 1 according to an embodiment of the present invention. The network layers of the present embodiment include an upper layer 300, a media independent handover (MIH) layer 310, and a lower layer 320. The upper layer 300 refers to a third layer and the upper layers (that is, an Internet protocol (IP) layer, a mobile IP layer, a transport layer, an application layer, etc.) of the third layer among the 7 layers defined by the Open Systems Interconnection (OSI) reference model. The lower layer 320 refers to a second layer and the lower layers (that is, a link layer, a physical layer, etc.) of the second layer, among the 7 layers defined by the OSI reference model.

The MIH layer 310 is not defined by the OSI reference model but by the IEEE 802.21 standards. The MIH layer 310 corresponds to a 2.5th layer between the lower layer 320 and the upper layer 300 and supports handover between the lower layer 320 and the upper layer 300. The MIH layer 310 supports handover between different types of links, regardless of the media type of a link to which the MN 1 is connected. In particular, the MIH layer 310 supports handover between different types of links, regardless of the type of link interfaces of the lower layer 320. The MIH layer 310 may include a media independent event service (MIES) provider 312, a media independent information service (MIIS) provider 314, and a media independent command service (MICS) provider 316.

The MIES provider 312 detects the generation of an event related to handover between various links and notifies the upper layer 300 about the generation of the event. Events include variances in a network and objects in the lower layer 320. The MIIS provider 314 acquires handover information from an IS that collects handover information. The MICS provider 316 receives a command input by a user from the upper layer 300 to control handover in the lower layer 320, i.e., handover in a link layer.

The handover apparatus and method according to aspects of the present invention may relate to the MIIS provider 314. The MIIS provider 314 receives the handover information from the IS to allow the MIES provider 312 and the MICS provider 316 to assist handover in the upper layer 300 and the lower layer 320. The MIH layer 310 of the MN 1, an MIH layer of the IS 200, and an MIH layer of a PoA communicate data using an MIH protocol.

FIG. 10 illustrates a general format of a message using the MIH protocol according to an embodiment of the present invention. The message (and the information included in the message) using the MIH protocol has a format of Type-Length-Value, referred to as a TLV format. Afield Type indicates a type of data. A field Length indicates a length of a field Value. The field Value indicates a value of data, and has the TLV format.

FIG. 11 illustrates a format of an information request message 400 according to an embodiment of the present invention. The information request message 400 has a TLV format. A field Type of the information request message 400 has a value of “MIIS_TLV_QUERY”, and the length is variable according to a value of a field Value. The field Value of the information request message 400 can have two pieces of information. One is a field Querier Location 410 and another is a field Reporting Template 420 indicating what information is requested.

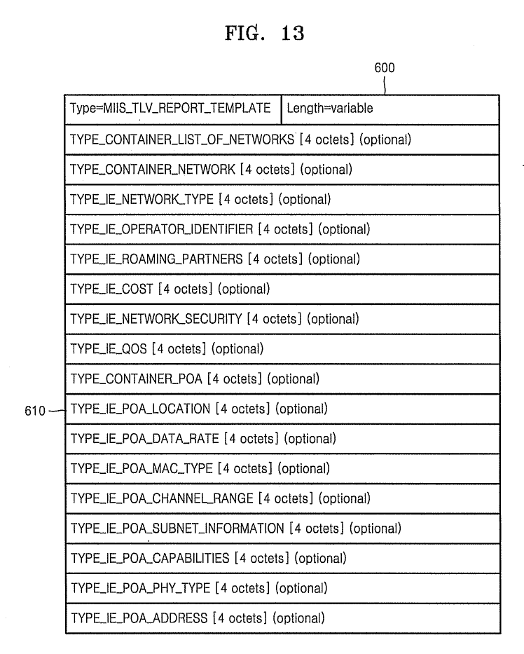

FIG. 12 illustrates a format of the field Querier Location 410 according to an embodiment of the present invention. A Type of the field Querier Location has a value of “MIIS_TLV_QUERIER_LOCATION” and the length is variable according to a value of a field Value. A field Value of the Querier Location TLV has the same value as a PoA location information element. A querier is the MN 1 requesting handover information. Therefore, the querier location indicates the location of the MN 1. A PoA identifier that is an intrinsic value of a PoA is used as the location of the MN 1. A format of a message including the PoA identifier will now be described with reference to FIG. 13.

FIG. 13 illustrates a format 600 of the field Reporting Template 420 illustrated in FIG. 11 according to an embodiment of the present invention. The format 600 includes the content of the field Reporting Template 420. Handover information transmitted to the MN 1 by an IS will now be described with reference to FIGS. 11 and 13. The handover information is in the form of an information element (IE). The IE has a TLV format. A name of information to be transmitted is included in a field Type. Content of information to be transmitted is included in a field Value. The length of the field Value is included in a field Length.

The Reporting Template TLV 600 can include Type fields of a plurality of IEs in the field Value. “Optional” means that the field Value may include or may not include that IE field. For example, the Reporting Template TLV 420 illustrated in FIG. 11 may not be included in the field Value of the information request message 400. In this case, the IS transmits every related handover information to the MN 1. However, if the Reporting Template TLV 420 illustrated in FIG. 11 is included in the field Value of the information request message 400, handover information corresponding to the IEs illustrated in FIG. 13 may be transmitted to the MN 1.

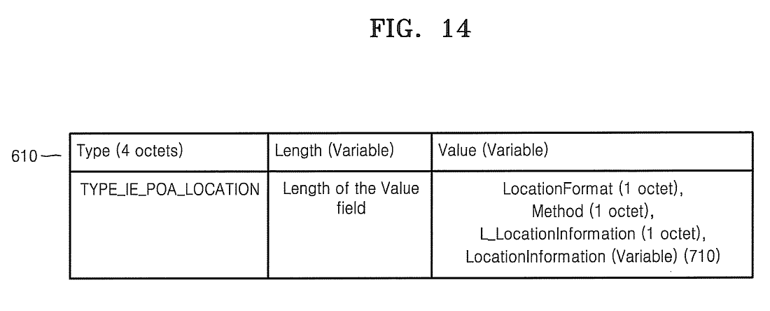

One of the IEs is a PoA location IE 610. FIG. 14 illustrates a format of the PoA location IE 610 according to an embodiment of the present invention. A field Type of the PoA location IE 610 has a value of “TYPE_IE_POA_LOCATION”, and a field Length thereof has a value of a field Value. The field Value of the PoA location IE 610 includes a plurality of fields. A field LocationFormat indicates a type of location information. Here, 0 indicates civic location information, 1 indicates geospatial location information, and 2 indicates a PoA identifier. A field Method indicates a method of providing the location information. Here, 0 indicates a GPS, 1 indicates an assisted GPS, 2 indicates a manual method, 3 indicates a dynamic host configuration protocol (DHCP), 4 indicates triangulation, 5 indicates a cell, 6 indicates an AP in IEEE 802.11 WLAN, and 7 indicates the PoA identifier. A field L_LocationInformation indicates the length thereof. Afield LocationInformation 710 indicates substantial location information. The values of the field LocationInformation may differ depending on the type of location information.

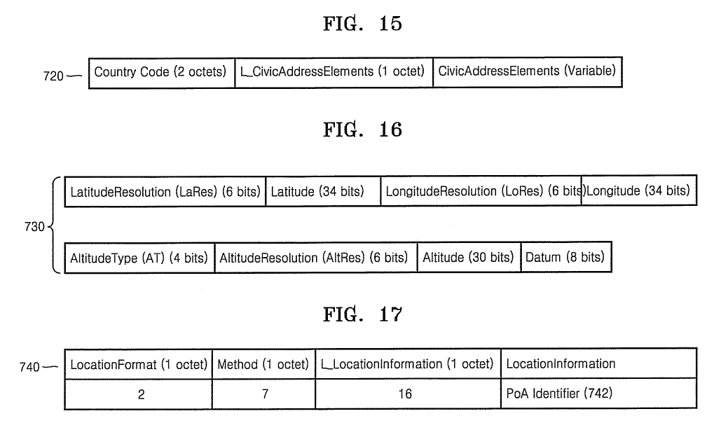

FIG. 15 illustrates a value 720 of the field LocationInformation 710 when the type of location information is civic location information. The civic location information indicates location based on an actual address system. In detail, the address system including countries, states, cities/counties streets, and numbers (in foreign countries, countries, provinces, communities, street names, street numbers, and the like) is used to indicate location. The value 720 of the field LocationInformation 710 includes a country code, the length of a civic address element L_CivicAddressElements, and a civic address element CivicAddressElements except for a country.

FIG. 16 illustrates a value 730 of the field LocationInformation 710 when the type of location information is geospatial location information. The geospatial location information indicates latitude, altitude, and/or longitude. The value 730 of the field LocationInformation 710 includes resolution of latitude information LatitudeResolution, the latitude information Latitude, resolution of longitude information LongitudeResolution, longitude information Longitude, a type of the altitude AltitudeType, resolution of altitude information AltitudeResolution, Altitude information Altitude, and datum Datum.

FIG. 17 illustrates the contents 740 of the field Value of a PoA location IE when the type of information location is a PoA identifier. FIGS. 14 through 17 illustrate the contents of the PoA identifier indicating the location of a PoA. However, as shown in the field Value of FIG. 12, the field Value of the PoA location IE has the same format as the field Value of the Querier Location TLV indicating the location of the MN 1.

In an embodiment of the present invention, the MN 1 transmits the Querier Location TLV including a PoA identifier of a current PoA to which the MN 1 is connected to the IS. The content 740 is the contents of the field Value of the Querier Location TLV. The IS determines PoAs adjacent to the current PoA (see operation 310 in FIG. 5) and then transmits PoA identifiers of the adjacent PoAs as information about the adjacent PoAs to the MN 1 (see operation 320 in FIG. 5). The content 740 is the contents of the field Value of the PoA location IE included in an information response message.

In the contents 740 of the field Value of the PoA location IE 610 when the type of information location is a PoA identifier, a field LocationFormat has a value of 2 indicating the PoA identifier. The field Method should have a value indicating the PoA identifier. For example, as described above, the field Method may have a value of 7 indicating the use of a PoA identifier. A field L_LocationInformation indicates the length of the field LocationFormat. A PoA Identifier 742 may have 16 octets, i.e., 126-bit length. In this case, the field L_LocationInformation has a value of 16. The field LocationFormat has the PoA Identifier 742 as a value thereof.

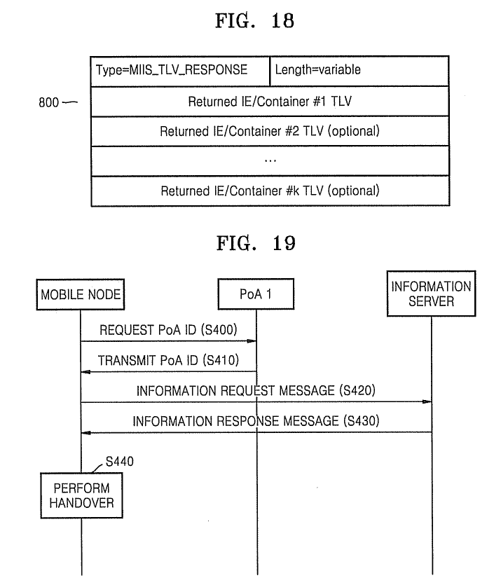

FIG. 18 illustrates a format of an information response message 800 according to an embodiment of the present invention. The information response message 800 is used to transmit handover information from an IS to an MN. The information response message 800 has a TLV format. A field Type of the information response message 800 has a value of “MIIS_TLV_RESPONSE”, and a field Value thereof includes one or more IEs to be transmitted to the MN. The information response message may include a plurality of PoA location IEs.

FIG. 19 is a flowchart of a handover performing method including an exchange of messages between objects according to an embodiment of the present invention. The MN 1 receives a PoA ID from PoA 1 to which the MN is connected and requests handover information from an IS.

The MN requests the PoA ID from the PoA 1 (operation 400). The PoA 1 transmits the PoA 1's PoA ID to the MN in response to the request (operation 410). These operations may be performed by exchanging messages between an MIH layer of the MN and an MIH layer of the PoA 1. The messages may use an MIH protocol. The MN transmits a Querier Location TLV of an information request message including the PoA ID of the PoA1 to the IS (Operation 420).

The IS detects the PoA ID from the Querier Location TLV of the information request message, and determines PoAs adjacent to the PoA corresponding to the detected PoA ID. The IS determines IEs relating to the determined adjacent PoAs. If the MN requests a specific IE, the IS selects the requested IE and includes the selected IE in an information response message. If the MN does not request the specific IE, the IS includes the determined IEs relating to the adjacent PoAs in the information response message. The IS transmits the information response message to the MN (Operation 430).

The MN performs handover using the IEs included in the information response message (Operation 440). For example, the MN may perform handover using the IEs by comparing received handover information and connecting to a PoA supporting a specific protocol from the adjacent PoAs or by selecting the PoA supporting the specific protocol from the adjacent PoAs and connecting to the selected PoA.

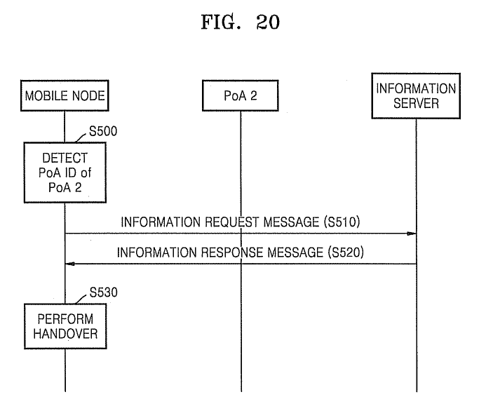

FIG. 20 is a flowchart of a handover technique when an MN knows the PoA ID of a current PoA 2 to which the MN is connected according to an embodiment of the present invention. The MN detects a PoA location IE corresponding to the current PoA 2 from an information response message received from an IS and obtains a PoA ID from a field Value of the detected PoA location IE (Operation 500). Operations 510 through 530 are completely similar to Operations 420 through 440 illustrated in FIG. 19, and therefore, a detailed description thereof is omitted.

The handover techniques according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc., including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention. Although a few embodiments of the present invention have been shown and described, it would be appreciated by those skilled in the art that changes may be made in this embodiment without departing from the principles and spirit of the invention, the scope of which is defined in the claims and their equivalents.

According to aspects of the present invention, a mobile node that does not include a GPS or does not support a specific protocol transmits the location thereof to an IS using an PoA identifier that is an intrinsic value of a current PoA to which the MN is connected, so that the IS can be informed of the current PoA, and quickly and precisely determine adjacent PoAs for performing handover. Therefore, the IS can reduce a required amount of handover information to the MN, the MN can quickly perform handover, and an amount of resources such as memory can be reduced, thereby increasing the quality of a user's mobile call.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of performing handover in a mobile node comprising:
determining an intrinsic value of a current PoA (point of attachment) to which the mobile node is connected; and
performing handover using the determined intrinsic value.

2. The method of claim 1, wherein the intrinsic value of the current PoA is a PoA identifier of the current PoA.

3. The method of claim 1, wherein the determining of the intrinsic value of the current PoA comprises:
transmitting a message requesting the intrinsic value to the current PoA; and
receiving a message including the intrinsic value from the current PoA.

4. The method of claim 3, wherein the message requesting the intrinsic value and the message including the intrinsic value use an MIH (media independent handover) protocol.

5. The method of claim 1, wherein the determining of the intrinsic value of the current PoA comprises:
detecting the intrinsic value from information about the current PoA received from an information server.

6. The method of claim 1, wherein the performing of handover using the determined intrinsic value comprises:
transmitting an information request message including the determined intrinsic value to the information server to request handover information from the information server;
receiving an information response message including information on PoAs adjacent to the current PoA corresponding to the intrinsic value from the information server; and
performing handover using the received information on the adjacent PoAs.

7. An apparatus to perform handover using a mobile node comprising:
an intrinsic value determining unit to determine an intrinsic value of a current point of attachment (PoA) to which the mobile node is connected; and
a handover performing unit to perform handover using the determined intrinsic value.

8. The apparatus of claim 7, wherein the intrinsic value of the current PoA is a PoA identifier of the current PoA.

9. The apparatus of claim 7, wherein the intrinsic value determining unit transmits a message to the current PoA requesting the intrinsic value and receives a message including the intrinsic value from the current PoA according to an MIH protocol.

10. The apparatus of claim 7, wherein the intrinsic value determining unit detects the intrinsic value from information about the current PoA received from an information server.

11. The apparatus of claim 7, wherein the handover performing unit transmits an information request message including the determined intrinsic value to the information server to request handover information to the information server, receives an information response message including information on PoAs adjacent to a PoA corresponding to the intrinsic value from the information server, and performs handover using the received information on the adjacent PoAs.

12. A method of transmitting handover information from an information server to a mobile node comprising:
receiving an information request message including an intrinsic value of a current point of attachment (PoA) to which the mobile node is connected from the mobile node;
determining PoAs adjacent to the current PoA corresponding to the intrinsic value; and
transmitting an information response message including information on the determined adjacent PoAs to the mobile node.

13. The method of claim 12, wherein the intrinsic value of the current PoA is a PoA identifier of the current PoA.

14. The method of claim 12, wherein the information on the determined adjacent PoAs includes intrinsic values of the determined adjacent PoAs.

15. An information server to transmit handover information to a mobile node comprising:
a message receiver to receive an information request message from the mobile node including an intrinsic value of a current point of attachment (PoA) to which the mobile node is connected;
an adjacent PoA determiner to determine PoAs adjacent to the current PoA corresponding to the intrinsic value; and
a message transmitter to transmit an information response message including information on the determined adjacent PoAs to the mobile node.

16. The information server of claim 15, wherein the intrinsic value of the current PoA is a PoA identifier of the current PoA.

17. The information server of claim 15, wherein the information on the determined adjacent PoAs includes intrinsic values of the determined adjacent PoAs.

18. An information recording medium storing a message usable to request information from an information server necessary to perform a handover, wherein the message is an information request message including an intrinsic value of a current point of attachment (PoA) to which the mobile node is connected.

19. The information recording medium of claim 18, wherein the intrinsic value of the current PoA is a PoA identifier of the current PoA.

20. An information recording medium storing a message usable to transmit handover information from an information server to a mobile node when the mobile node performs a handover, wherein the message is an information response message including an intrinsic value of a current point of attachment (PoA) to which the mobile node is connected.

21. The information recording medium of claim 20, wherein the intrinsic value of the current PoA is a PoA identifier of the current PoA.

22. A computer readable recording medium having embodied thereon a computer program to execute a method of performing handover in a mobile node, the method comprising:
determining an intrinsic value of a current point of attachment (PoA) to which the mobile node is connected; and
performing handover using the determined intrinsic value.

23. A computer readable recording medium having embodied thereon a computer program to execute a method of transmitting handover information from an information server to a mobile node, the method comprising:
receiving an information request message including an intrinsic value of a current point of attachment (PoA) to which the mobile node is connected from the mobile node;
determining PoAs adjacent to a PoA corresponding to the intrinsic value; and
transmitting an information response message including information on the determined adjacent PoAs to the mobile node.

24. The information storage medium of claim 18, wherein the message is in a type-length-value format.

25. The information storage medium of claim 18, wherein:
the message comprises a Querier Location field, and
the intrinsic value of the PoA is included in the Querier Location field.

26. The information storage medium of claim 18, wherein:
the message comprises a PoA location information element (IE), and
the intrinsic value of the PoA is included in the PoA location IE.

27. The information storage medium of claim 26, wherein the PoA location information element IE comprises:
a type field identifying the type of the PoA location information element IE;
a value field having a LocationFormat field indicating a type of location information, a Method field indicating a method of providing the location information, a field L_LocationInformation indicating the length of the location information, and a field LocationInformation having the location information; and
a length field indicating the length of the value field;
wherein the location information includes the intrinsic value of the PoA.

28. A network comprising:
a plurality of points of attachment (PoA) to provide mobile communication to a corresponding plurality of radio areas;
a mobile node to communicate with one of the plurality of points of attachment and to handover from one point of attachment to another point of attachment and to request, from the PoA with which the mobile node is communicating, an intrinsic value of the PoA; and
an information server to control a handover, to receive an information request from the mobile node including the intrinsic value of the PoA with which the mobile node is communicating, to determine an intrinsic value of a PoA adjacent to the PoA with which the mobile node is communicating, and to transmit the intrinsic values of the adjacent PoAs to the mobile node.

29. A mobile node to perform a handover, the mobile node comprising:
an intrinsic value determining unit to determine an intrinsic value of a current point of attachment (PoA) with which the mobile node is communicating and to determine intrinsic values of a plurality of adjacent PoAs adjacent to the current PoA; and
a handover unit to perform a handover from the current PoA to one of the adjacent PoAs using the intrinsic values determined by the intrinsic value determining unit.

30. The mobile node of claim 29, wherein the intrinsic value determining unit determines the intrinsic values of the adjacent PoAs by transmitting a request to an information server (IS) including the intrinsic value of the current PoA and receiving the intrinsic values of the adjacent PoAs from the information server in response to the request.

31. The mobile node of claim 29, wherein the intrinsic value determining unit determines the intrinsic value of the current PoA by transmitting a message to the current PoA requesting the intrinsic value.

32. The mobile node of claim 31, wherein the intrinsic value determining unit transmits the message using a media independent handover protocol.

33. The mobile node of claim 29, wherein the intrinsic value determining unit determines the intrinsic value without referring to extrinsic location information.

34. A method of performing a handover comprising:
determining location information irrespective of a global positioning system (GPS) or a particular radio protocol; and
handing a mobile node over from one point of attachment to another based on the location information.
